(19) United States
(12) Patent Application Publication
(10) Pub. No.: US 2024/0040388 A1
(43) Pub. Date: Feb. 1, 2024

(54) TECHNIQUES FOR MITIGATING INTER-NETWORK NODE INTERFERENCE IN WIRELESS COMMUNICATIONS

(71) Applicant: QUALCOMM Incorporated, San Diego, CA (US)

(72) Inventors: Qian ZHANG, Basking Rigde, NJ (US); Yan Zhou, San Diego, CA (US); Muhammad Sayed Khairy ABDELGHAFFAR, San Jose, CA (US); Ahmed Attia ABOTABL, San Diego, CA (US); Tao LUO, San Diego, CA (US)

(21) Appl. No.: 17/816,569

(22) Filed: Aug. 1, 2022

(51) Int. Cl. H04W 16/14; H04W 72/12; H04L 5/00

(52) U.S. Cl. CPC H04W 16/14; H04W 72/1231; H04L 5/0051; H04W 72/1263

(57) ABSTRACT

Aspects described herein relate to mitigating interference between network nodes operating in full duplex (FD). In some aspects, a victim network node can indicate, to an aggressor network node, a capability to cancel interference from the aggressor network node, receive one or more uplink signals from a device along with one or more downlink signals from the aggressor network node in a same time period, and cancel, based on the capability, the one or more downlink signals received from the aggressor network node from the one or more uplink signals received from the device. In other aspects, the victim network node can indicate certain uplink resources to the aggressor network node, which can avoid transmitting downlink communications over the indicated uplink resources.

### FIELD OF THE DISCLOSURE

Aspects of the present disclosure relate generally to wireless communication systems, and more particularly, to techniques for mitigating interference between network nodes.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, such as 5G NR, devices and/or node can use full-duplex (FD) operations to transmit and receive signals in a same time period, where the FD operations may be inter-subband where transmission and reception can occur in different subbands, or intra-subband where transmission and reception can occur in the same subband (or full frequency band).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a processor, memory coupled with the processor, and instructions stored in the memory. The instructions are operable, when executed by the processor, to cause the apparatus to indicate, to an aggressor network node, a capability to cancel interference from the aggressor network node, receive one or more uplink signals from a device along with one or more downlink signals from the aggressor network node in a same time period, and cancel, based on the capability, the one or more downlink signals received from the aggressor network node from the one or more uplink signals received from the device.

In another aspect, an apparatus for wireless communication is provided that includes a processor, memory coupled with the processor, and instructions stored in the memory. The instructions are operable, when executed by the processor, to cause the apparatus to receive, from a victim network node, a capability to cancel interference from the network node, and transmit, based on the capability, one or more downlink signals in an uplink symbol for the victim network node over which one or more devices transmit uplink signals to the victim network node.

In another aspect, a method for wireless communication at a network node is provided that includes indicating, to an aggressor network node, a capability to cancel interference from the aggressor network node, receiving one or more uplink signals from a device along with one or more downlink signals from the aggressor network node in a same time period, and cancelling, based on the capability, the one or more downlink signals received from the aggressor network node from the one or more uplink signals received from the device.

In another aspect, a method for wireless communication at a network node is provided that includes receiving, from a victim network node, a capability to cancel interference from the network node, and transmitting, based on the capability, one or more downlink signals in an uplink symbol for the victim network node over which one or more devices transmit uplink signals to the victim network node.

In other aspects, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a base station, in accordance with various aspects of the present disclosure;

FIG. 4 is a flow chart illustrating an example of a method for cancelling interference from an aggressor network node, in accordance with aspects described herein;

FIG. 5 is a flow chart illustrating an example of a method for transmitting downlink signals in an uplink symbol of a victim network node, in accordance with aspects described herein;

FIG. 6 is a flow chart illustrating an example of a method for indicating certain uplink resources to an aggressor network node for avoiding downlink transmissions, in accordance with aspects described herein;

FIG. 7 is a flow chart illustrating an example of a method for avoiding downlink transmissions over certain uplink resources indicated by a victim network node, in accordance with aspects described herein;

FIG. 8 is a flow chart illustrating an example of a method for indicating certain downlink resources to an aggressor network node for avoiding scheduling uplink transmissions, in accordance with aspects described herein;

FIG. 9 is a flow chart illustrating an example of a method for avoiding scheduling uplink transmissions over certain uplink resources indicated by a victim network node, in accordance with aspects described herein;

FIG. 10 illustrates an example of a wireless communication system with possible cross-link interference (CLI), in accordance with aspects described herein; and

FIG. 11 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to mitigating interference between network nodes that are capable of full-duplex (FD) operations in a wireless network. For example, network nodes in some wireless communication technologies, such as fifth generation (5G) new radio (NR), can communicate using subband non-overlapping FD, where uplink and downlink communications at the network node can be on different subbands of an operating frequency, and/or dynamic/flexible time division duplexing (TDD), where uplink and downlink communications may use the same operating frequency band. The network nodes, as described herein, can include base stations or gNBs, portions of a disaggregated base station or gNB, such as a centralized unit (CU), distributed unit (DU), and/or the like. In FD configurations, network nodes can concurrently transmit and receive signals in the same slot. For example, a slot can include a time period of multiple symbols (e.g., orthogonal frequency division multiplexing (OFDM) symbols, single carrier-frequency division multiplexing (SC-FDM) symbols, etc.). Using FD in the same slot can allow for an increased uplink duty cycle (e.g., as compared to TDD communications), which can reduce latency (e.g., by making it possible to receive downlink signals in uplink slots), improve uplink coverage, enhance system capacity, enhance resource utilization, enhance spectrum efficiency, enable flexible and dynamic uplink/downlink resource adaptation according to uplink/downlink traffic in a robust manner, etc.

In using FD communications, however, the network nodes, and/or devices communicating therewith, can experience or cause intra-subband or inter-subband cross-link interference (CLI) to one another. For example, one network node transmitting to a UE may cause CLI to another network node receiving from another UE in the same time periods, and/or a UE transmitting to a network node may cause CLI to another UE receiving from another network node. Where different subbands are used for uplink and downlink communications, this CLI may be inter-subband, and where the same frequency band or overlapping frequency bands are used for uplink and downlink communications, this CLI may be intra-band (or intra-subband).

In accordance with aspects described herein, a network node can include an advanced receiver for detecting signals from a neighboring network node that may interfere with communications at the network node, and can cancel the signals as interference from subsequent communications. The neighboring network node in this example is referred to herein as an aggressor network node, and the network node being potentially interfered is referred to herein as a victim network node. In one example, the victim network node can indicate to the aggressor network node a capability to cancel the interference, and the aggressor network node can accordingly determine whether to transmit downlink signals in uplink time periods based on the capability, determine whether to facilitate or allow a training period during which the victim network node can detect signals from the aggressor network node for interference cancellation, etc. In another example, the victim network node can indicate, to the aggressor network node, time and/or frequency resources requested to be free from interference, such as uplink reference signal resources, and the aggressor network node can refrain from transmitting over the time and/or frequency resources.

In any case, in these examples, the network nodes can mitigate interference with one another in FD operations by cancelling the interference or preventing the interference from occurring. This can improve communication quality at the network nodes, which can improve spectrum usage, and thus performance at UEs using the network nodes, etc.

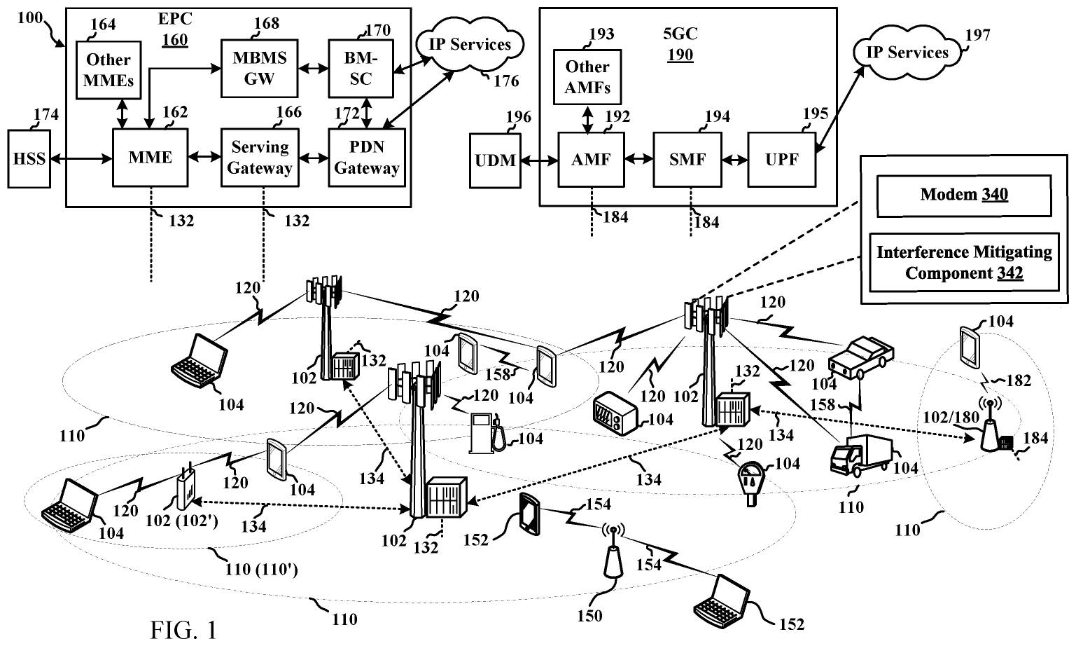

The described features will be presented in more detail below with reference to FIGS. 1-11.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and interference mitigating component 342 for mitigating CLI between network nodes operating in FD, in accordance with aspects described herein. Though a base station 102 is shown as having the modem 340 and interference mitigating component 342, this is one illustrative example, and substantially any node or type of node may include a modem 340 and interference mitigating component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, one base station 102 operating in FD can interference with another base station 102 operating in FD, including CLI where downlink transmissions from one base station 102 can interfere with uplink transmissions received from a UE 104 at another base station 102. In one example, the base stations 102 can include an interference mitigating component 342 to facilitate mitigating interference whether from an aggressor base station 102 or victim base station 102. For example, interference mitigating component 342 of a victim base station 102 can indicate a capability to perform interference cancellation of signals received from an aggressor base station 102, perform a training phase to detect signals from the aggressor network node 102, cancel interference from signals of the aggressor base station 102 from uplink communications, indicate certain uplink resources over which the aggressor base station 102 should not transmit downlink communications, etc. For example, interference mitigating component 342 of an aggressor base station 102 can receive an indication of a capability of the victim base station 102 to perform interference cancellation of signals received from the aggressor base station 102, transmit downlink signals during uplink symbols of the victim base station 102, receive an indication of certain uplink resources of the victim base station 102 and refrain from transmitting downlink communications over the certain uplink resources, etc. In these and various examples described herein, interference mitigating component 342 can mitigate CLI between the base stations 102.

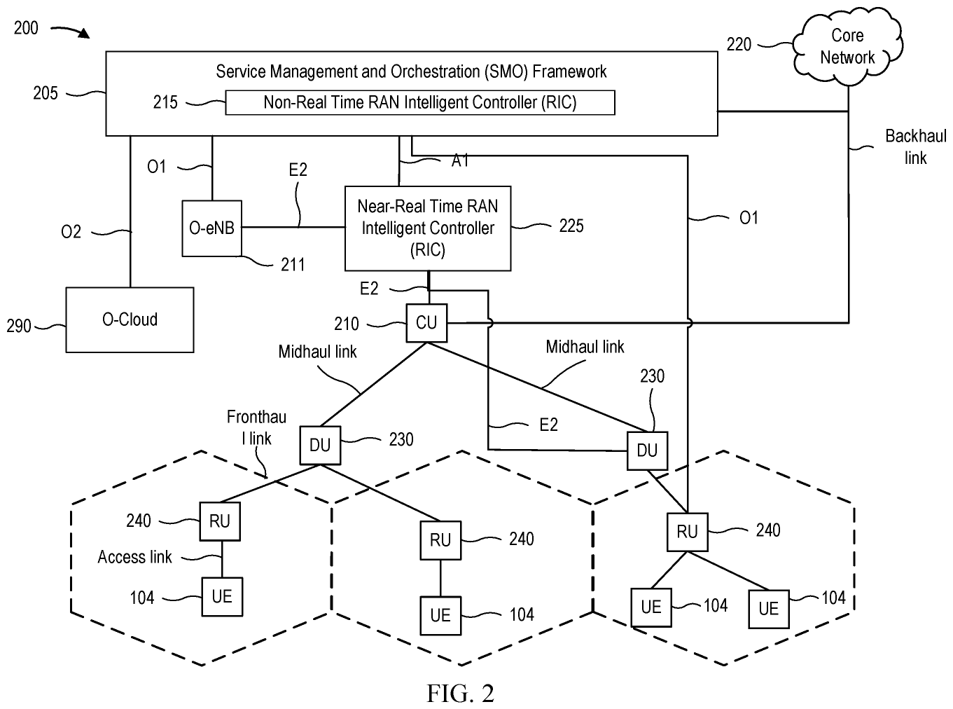

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In an example, interference mitigating component 342, as described herein, can be at least partially implemented within one or more DUs 230 to mitigating CLI among DUs 230 (or between a DU 230 and another base station). In one example, a victim DU 230 can include the interference mitigating component 342 to mitigate or cancel interference from an aggressor DU 230 (which may have the same CU 210 or otherwise), and/or an aggressor DU 230 can include the interference mitigating component 342 to mitigate or cancel interference potentially caused to a victim DU 230 (which may have the same CU 210 or otherwise), etc. In accordance with some aspects described herein, parameters or indications related to interference mitigation can be communicated between DUs 230 using F1 signaling between DUs 230 where the DUs have the same CU 210. In another example, the parameters or indications related to interference mitigation can be communicated between DUs 230 using F1 and Xn signaling between DUs 230 where the DUs have different CUs 210 (e.g., Xn between the CUs 210 and F1 from the respective DU 210 to DU 230).

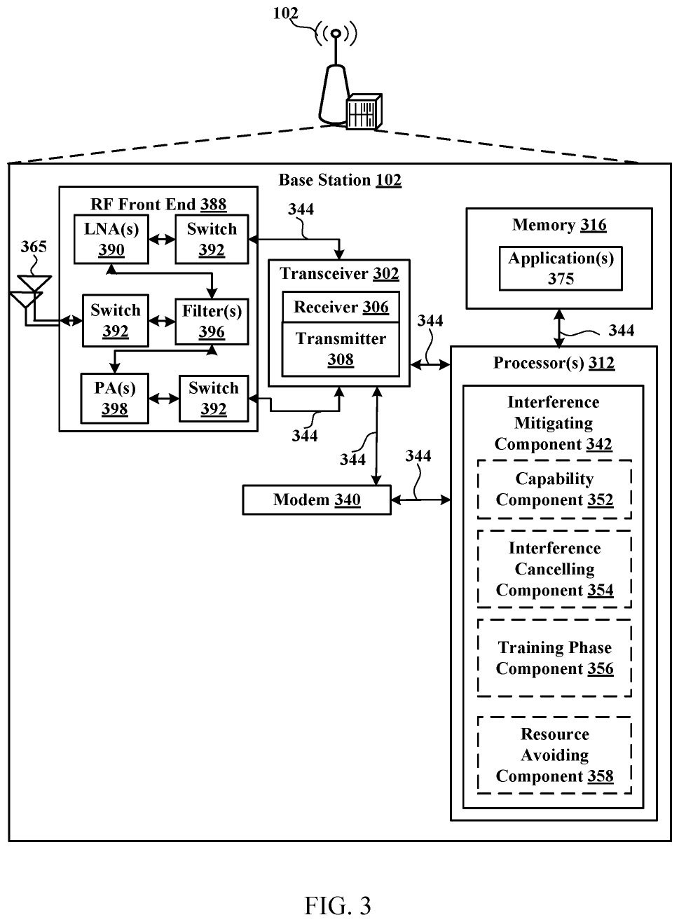

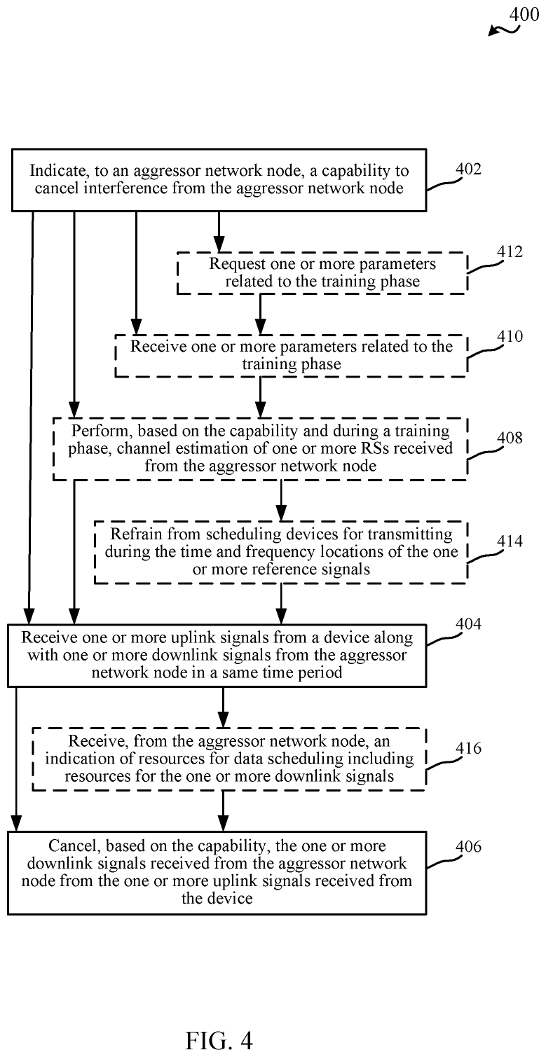

Turning now to FIGS. 3-11, aspects are depicted with reference to one or more components and one or more methods that may perform the actions or operations described herein, where aspects in dashed line may be optional. Although the operations described below in FIGS. 4-9 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of base station 102 may include a variety of components, some of which have already been described above and are described further herein, including components such as one or more processors 312 and memory 316 and transceiver 302 in communication via one or more buses 344, which may operate in conjunction with modem 340 and/or interference mitigating component 342 for mitigating CLI between network nodes operating in FD, in accordance with aspects described herein. For example, base station 102 can include any type of network node, including a monolithic base station, a portion of a disaggregated base station (e.g., a DU), and/or the like.

In an aspect, the one or more processors 312 can include a modem 340 and/or can be part of the modem 340 that uses one or more modem processors. Thus, the various functions related to interference mitigating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with interference mitigating component 342 may be performed by transceiver 302.

Also, memory 316 may be configured to store data used herein and/or local versions of applications 375 or interference mitigating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining interference mitigating component 342 and/or one or more of its subcomponents, and/or data associated therewith, when base station 102 is operating at least one processor 312 to execute interference mitigating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), reference signal received quality (RSRQ), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, base station 102 may include RF front end 388, which may operate in communication with one or more antennas 365 and transceiver 302 for receiving and transmitting radio transmissions, for example, wireless communications transmitted by a UE 104, another base station 102, etc. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver 302 may be tuned to operate at specified frequencies such that base station 102 can communicate with, for example, a UE 104, one or more base stations 102, etc. In an aspect, for example, modem 340 can configure transceiver 302 to operate at a specified frequency and power level based on the base station configuration of the base station 102 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of base station 102 (e.g., RF front end 388, transceiver 302) to enable transmission and/or reception of signals from a UE 104 or other base stations 102 based on a specified modem configuration. In an aspect, the modem configuration can be based on the mode of the modem and the frequency band in use. In another aspect, the modem configuration can be based on base station configuration information associated with base station 102.

In an aspect, interference mitigating component 342 can optionally include a capability component 352 for indicating or receiving an indication of a capability for performing interference cancellation of signals from an aggressor network node, an interference cancelling component 354 for cancelling interference from signals from an aggressor network node, a training phase component 356 for performing a training phase to acquire or detect signals for interference cancellation, and/or a resource avoiding component 358 for indicating resources to be avoided or avoiding transmitting over resources to facilitate interference mitigation for a victim network node, in accordance with aspects described herein.

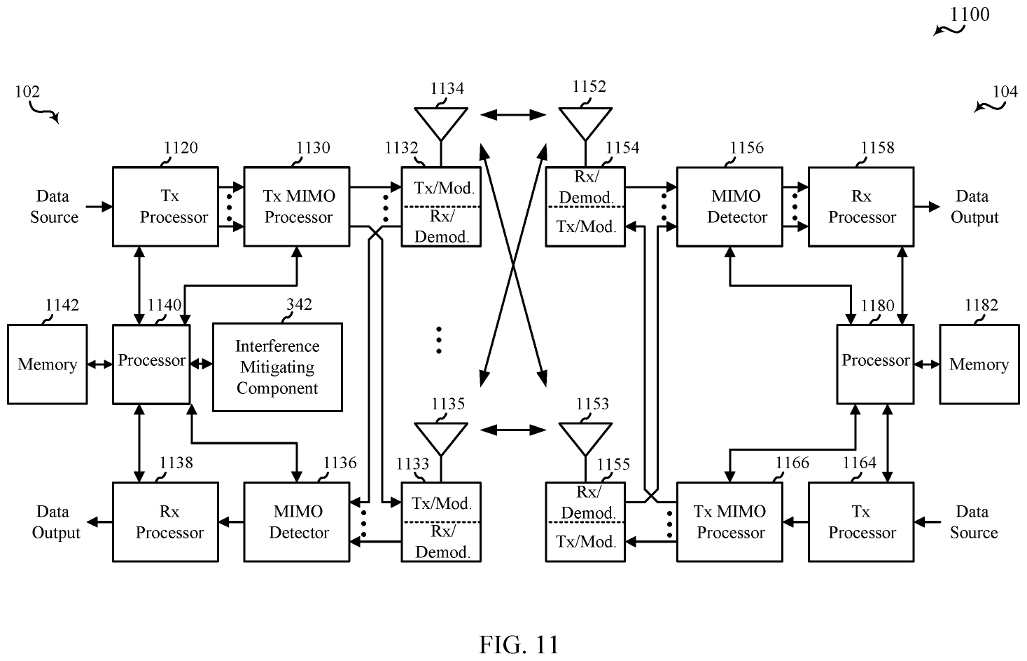

In an aspect, the processor(s) 312 may correspond to one or more of the processors described in connection with the UE in FIG. 11. Similarly, the memory 316 may correspond to the memory described in connection with the UE in FIG. 11.

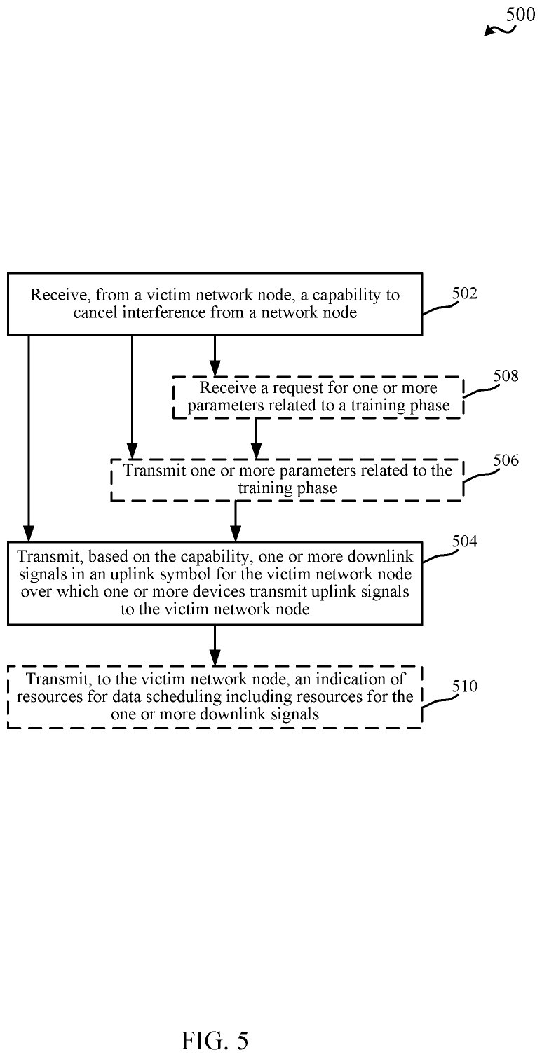

FIG. 4 illustrates a flow chart of an example of a method 400 for cancelling interference from an aggressor network node, in accordance with aspects described herein. FIG. 5 illustrates a flow chart of an example of a method 500 for transmitting downlink signals in an uplink symbol of a victim network node, in accordance with aspects described herein. In an example, a first network node, such as a base station 102 or gNB, or portion of a disaggregated base station 102 or gNB, etc., operating as a victim network node, can perform the functions described in method 400 using one or more of the components described in FIGS. 1 and 3. In an example, a second network node, such as a base station 102 or gNB, or portion of a disaggregated base station 102 or gNB, etc., operating as an aggressor network node, can perform the functions described in method 500 using one or more of the components described in FIGS. 1 and 3. Though methods 400 and 500 are described in conjunction with one another for ease of explanation, the methods are not required to be performed in conjunction, and different network nodes can, or can be configured to, independently perform the different methods.

In method 400, at Block 402, a capability to cancel interference from an aggressor network node can be indicated to the aggressor network node. In an aspect, capability component 352, e.g., in conjunction with processor(s) 312, memory 316, transceiver 302, interference mitigating component 342, etc., of a victim network node can indicate, to the aggressor network node (e.g., a different base station 102 or gNB, a portion of a different disaggregated base station 102 or gNB, etc.), a capability to cancel interference from the aggressor network node. For example, capability component 352 of a victim network node can transmit an indication of the capability or one or more parameters related to the capability. In an example, the indication can indicate that the victim network node has an interference cancellation receiver capable of cancelling interference from aggressor network nodes. The indication can be an explicit indication signaled to the aggressor network node using backhaul (BH) or over-the-air (OTA) signaling, or an implicit indication of a parameter that allows the aggressor network node to transmit downlink signals on an uplink symbol of the victim network node, such as a certain transmit power limit, etc. In either case, for example and as described above, capability component 352 can transmit the indication to the aggressor network node using F1 interface (e.g., as defined in third generation partnership project (3GPP) technical specification (TS) 38.473) where the victim and aggressor network nodes have the same CU, or can additionally use an Xn interface (e.g., as defined in 3GPP TS 38.423) between CUs where the victim and aggressor network nodes have different CUs.

In method 500, at Block 502, a capability to cancel interference from a network node can be received from a victim network node. In an aspect, capability component 352, e.g., in conjunction with processor(s) 312, memory 316, transceiver 302, interference mitigating component 342, etc., of an aggressor network node can receive, from the victim network node (e.g., a different base station 102 or gNB, a portion of a different disaggregated base station 102 or gNB, etc.), the capability to cancel interference from the network node (e.g., from the base station 102 or gNB, portion of a base station 102 or gNB, etc., performing as an aggressor network node). For example, capability component 352 of an aggressor network node can receive an explicit or implicit indication of the capability, as described above (e.g., an explicit indication signaled using BH or OTA signaling, a parameter indicating the capability such as a certain transmit power limit, etc.).

In method 500, at Block 504, one or more downlink signals can be transmitted, based on the capability, in an uplink symbol for the victim network node over which one or more devices transmit uplink signals to the victim network node. In an aspect, interference mitigating component 342, e.g., in conjunction with processor(s) 312, memory 316, transceiver 302, etc., of an aggressor network node, can transmit, based on the capability, one or more downlink signals in an uplink symbol for the victim network node over which one or more devices transmit uplink signals to the victim network node. As described, for example, the one or more downlink signals can cause CLI to the uplink signals as received by the victim network node. Based on the capability indicated by the victim network node, however, the aggressor network node can schedule downlink communications knowing that the victim network node has the ability to cancel the downlink communications to mitigate the CLI. As described, in one example, the CLI may be inter-subband where the uplink signals are in a different subband than the downlink communications, or may be intra-band (or intra-subband) where the uplink signals are at least partially in the same frequency resources (the same band or subband) as the downlink communications.

In one example, interference mitigating component 342 of the aggressor network node can transmit the downlink signals based on parameters related to the capability as received from the victim network node, such as a transmit power limit. For example, interference mitigating component 342 can apply the transmit power limit over symbols known to include uplink communications at the victim network node. In an example, the aggressor network node can know the slot format (e.g., the communication direction assigned to symbols, the communication direction assigned to subbands, etc.) which can be negotiated between the network nodes, known as the same formats can be used by the network nodes, etc. In other examples, the victim network node can indicate the format used to the aggressor network node (e.g., via BH or OTA signaling).

In method 400, at Block 404, one or more uplink signals can be received from a device along with one or more downlink signals from the aggressor network node in a same time period. In an aspect, interference mitigating component 342, e.g., in conjunction with processor(s) 312, memory 316, transceiver 302, etc., can receive the one or more uplink signals from a device (e.g., a UE 104 served by the victim network node) along with the one or more signals from the aggressor network node in a same time period. For example, the aggressor network node can transmit the downlink signals based on the capability indicated by the victim network node and in symbols, subbands, etc. indicated as used for uplink by the victim network node.

In method 400, at Block 406, the one or more downlink signals received from the aggressor network node can be cancelled, based on the capability, from the one or more uplink signals received from the device. In an aspect, interference cancelling component 354, e.g., in conjunction with processor(s) 312, memory 316, transceiver 302, interference mitigating component 342, etc., can cancel, based on the capability, the one or more downlink signals received from the aggressor network node from the one or more uplink signals received from the device. For example, interference cancelling component 354 can remove the one or more downlink signals from the one or more uplink signals, which may include detecting the interference using an advanced receiver, as described herein. The victim network node can accordingly process the received uplink signals with interference from the downlink signals cancelled.

In method 400, optionally at Block 408, channel estimation of one or more RSs received from the aggressor network node can be performed based on the capability and during a training phase. In an aspect, training phase component 356, e.g., in conjunction with processor(s) 312, memory 316, transceiver 302, interference mitigating component 342, etc., of a victim network node can perform, based on the capability and during a training phase, channel estimation of one or more RSs received from the aggressor network node. For example, the training phase can be defined by a number of RSs being transmitted by an aggressor network node, defined over a time period (e.g., a number of slots or corresponding symbols) during which RSs are transmitted by the aggressor network node, etc. In one example, the capability indication can include an indication of a training phase. In another example, the aggressor network node may transmit an indication of the training phase for the victim network node, as described herein. For example, indication of a training phase for channel estimation can aid in interference cancellation, at least for fully overlapped FD. In an example, during the training phase, training phase component 356 can receive and/or measure reference signals transmitted by the aggressor network node for detecting the signals to assist in cancelling the corresponding downlink signals from uplink communications from the device (e.g., at Block 406). In various examples described herein, the reference signals may include demodulation reference signals (DMRSs), channel state information reference signals (CSI-RSs), synchronization signal blocks (SSBs), DMRS of control resource sets (CORESETs), other training-specific reference signals, etc.

In method 400, optionally at Block 410, one or more parameters related to the training phase can be received. In an aspect, training phase component 356, e.g., in conjunction with processor(s) 312, memory 316, transceiver 302, interference mitigating component 342, etc., of a victim network node can receive one or more parameters related to the training phase. For example, the one or more parameters can include time and/or frequency locations of the one or more reference signals. In an example, training phase component 356 can receive the one or more parameters from the aggressor network node, from a configuration that may be common among the aggressor network node and victim network node, etc. For example, training phase component 356, whether by request or otherwise, may know the training RS time and/or frequency locations of the interfering neighboring aggressor network node so the victim network node can estimate about the channel using the training RS for data recovery and/or future interference cancellation. In one example, the aggressor network node can signal the training RS time and/or frequency locations and/or other data scheduling assistance information to the victim network node.

In one specific example, the aggressor network node can signal DMRS and data scheduling assistance information to the victim network node, where the DMRS may be aperiodic, periodic, or semi-persistent. In this example, training phase component 356 can receive the DMRS and data scheduling assistance information, and can accordingly receive and measure or otherwise process the DMRS during the time and/or over the frequency resources to facilitate cancelling interference of corresponding downlink signals from one or more subsequent uplink signals.

Thus, in one example in method 500, optionally at Block 506, one or more parameters related to the training phase can be transmitted. In an aspect, training phase component 356, e.g., in conjunction with processor(s) 312, memory 316, transceiver 302, interference mitigating component 342, etc., of an aggressor network node can transmit the one or more parameters related to the training phase. As described, the one or more parameters may include training RS time and/or frequency locations and/or data scheduling assistance information to allow the victim network node to receive and measure or otherwise process the training RS for cancelling interference of corresponding downlink signals from one or more subsequent uplink signals. For example, training phase component 356 can transmit the one or more parameters to the victim network node using BH or OTA signaling, as described herein.

In one example, the one or more parameters may be communicated based on a request from the victim network node. In this example, in method 400, optionally at Block 412, one or more parameters related to the training phase can be requested. In an aspect, training phase component 356, e.g., in conjunction with processor(s) 312, memory 316, transceiver 302, interference mitigating component 342, etc., of a victim network node can request the one or more parameters related to the training phase. For example, training phase component 356 can send the request to the aggressor network node using BH or OTA signaling, as described herein. In addition, in this example, in method 500, optionally at Block 508, a request for one or more parameters related to the training phase can be received. In an aspect, training phase component 356, e.g., in conjunction with processor(s) 312, memory 316, transceiver 302, interference mitigating component 342, etc., of an aggressor network node can receive the request for the one or more parameters related to the training phase (e.g., over BH or OTA signaling, etc.). In an example, training phase component 356 of an aggressor network node can transmit the one or more parameters based on receiving the request, where the one or more parameters can include time and/or frequency locations of RSs, data scheduling assistance information, etc., as described above.

In another example, training phase component 356 of an aggressor network node can signal, to a victim network node, e.g., via BH or OTA signaling, DMRS resource element (RE) pattern information for MIMO channel estimation. Training phase component 356 of the victim network node can receive the DMRS resource RE pattern information, and can use the information for performing MIMO channel estimation. For example, the one or more parameters of the DMRS RE pattern may include an indication of a number of code division multiplexing (CDM) groups, a per CDM group RE allocation, associated DMRS ports for transmission for MIMO channel estimation, etc. In one example, as described, the DMRS may be aperiodic, periodic, or semi-persistent. In another example, training phase component 356 of the aggressor network node can transmit one or more parameters regarding a downlink periodic or semi-persistent RS, such as a CSI-RS, SSB, etc., or a DMRS of CORESET scheduling. Training phase component 356 of the victim network node can receive the one or more parameters and can perform channel estimation based on the CSI-RS, SSB, DMRS of CORESET scheduling, etc., as received from the aggressor network node based on the one or more parameters.

In an example, where the DMRS is used during the training phase for channel estimation, training phase component 356 can perform the channel estimation based on the DMRS, and then this channel estimation can be used by interference cancelling component 354 to cancel interference of subsequent downlink data transmissions from the aggressor network node that may interfere with uplink communications from a device to the victim network node. In another example, where the CSI-RS, SSB, or DMRS of CORESET are used during the training phase for channel estimation, training phase component 356 can perform the channel estimation based on a first occasion of the CSI-RS, SSB, or DMRS of CORESET, and then this channel estimation can be used by interference cancelling component 354 to cancel interference of subsequent CSI-RS, SSB, or CORESET occasions from the aggressor network node that may interfere with uplink communications from a device to the victim network node. In one example, training phase component 356 of the aggressor network node may indicate to the victim network node (e.g., over BH or OTA signaling) the transmission occasions of CORESETs as some transmission occasions may not include CORESET. In addition, in an example, the first occasion of CSI-RS, SSB, or DMRS of CORESET can be the first occasion after the training phase begins. In some examples, the victim network node and/or aggressor network node can perform training phases at a fixed periodicity, based on one or more triggers (e.g., a change in signal power or interference of the downlink signals from the aggressor network node as received at the victim network node, etc.).

In method 400, optionally at Block 414, scheduling devices for transmitting during the time and frequency locations of the one or more reference signals can be refrained from. In an aspect, interference mitigating component 342, e.g., in conjunction with processor(s) 312, memory 316, transceiver 302, etc., of a victim network node can refrain from scheduling devices for transmitting during the time and frequency locations of the one or more reference signals. In an example, interference mitigating component 342 can mute uplink transmissions on the DMRS time and/or frequency locations for more accurate channel estimation. In another example, interference mitigating component 342 can mute uplink transmissions on the time and/or frequency locations of the first occasion of CSI-RS, SSB, or DMRS of CORESET for more accurate channel estimation, but may not mute the subsequent occasions of CSI-RS, SSB, or DMRS of CORESET as interference cancelling component 354 can cancel interference of these signals based on the channel estimation of the initial occasion.

In method 500, optionally at Block 510, an indication of resources for data scheduling including resources for the one or more downlink signals can be transmitted to the victim network node. In an aspect, interference mitigating component 342, e.g., in conjunction with processor(s) 312, memory 316, transceiver 302, etc., of an aggressor network node can transmit, to the victim network node, the indication of resources for data scheduling including resources for the one or more downlink signals. In method 400, optionally at Block 416, an indication of resources for data scheduling including resources for the one or more downlink signals can be received from the aggressor network node. In an aspect, interference mitigating component 342, e.g., in conjunction with processor(s) 312, memory 316, transceiver 302, etc., of a victim network node can receive, from the aggressor network node, the indication of resources for data scheduling including resources for the one or more downlink signals. For example, based on completing the training phase, the aggressor network node can indicate, to the victim network node, e.g., via BH or OTA signaling, its data scheduling assistance information to inform the victim network node where to perform the interference cancellation based on the training, e.g. on the aggressor network node's downlink data transmission or reference signal transmission (e.g. CSI-RS/SSB) at the victim network node having the interference cancellation receiver capability.

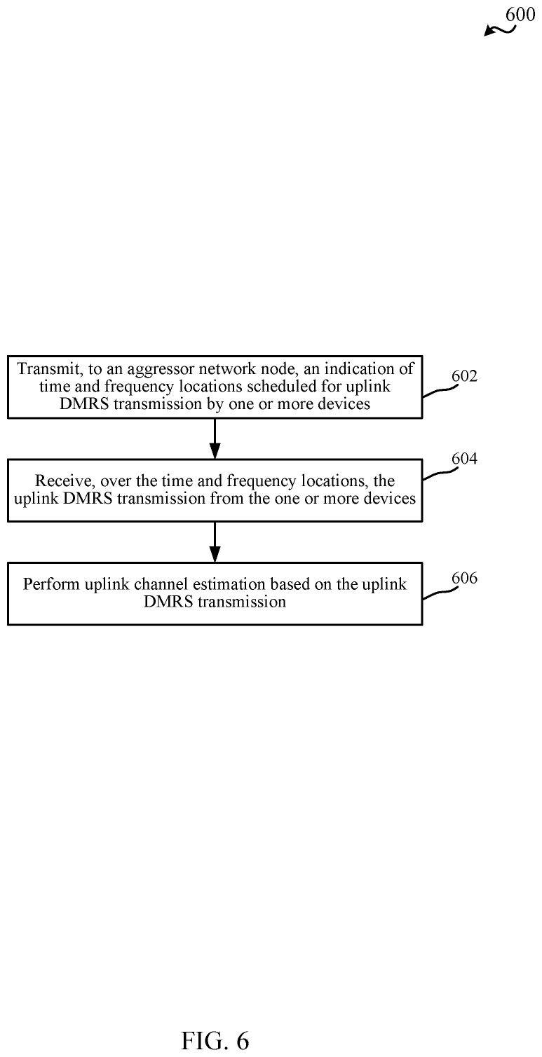

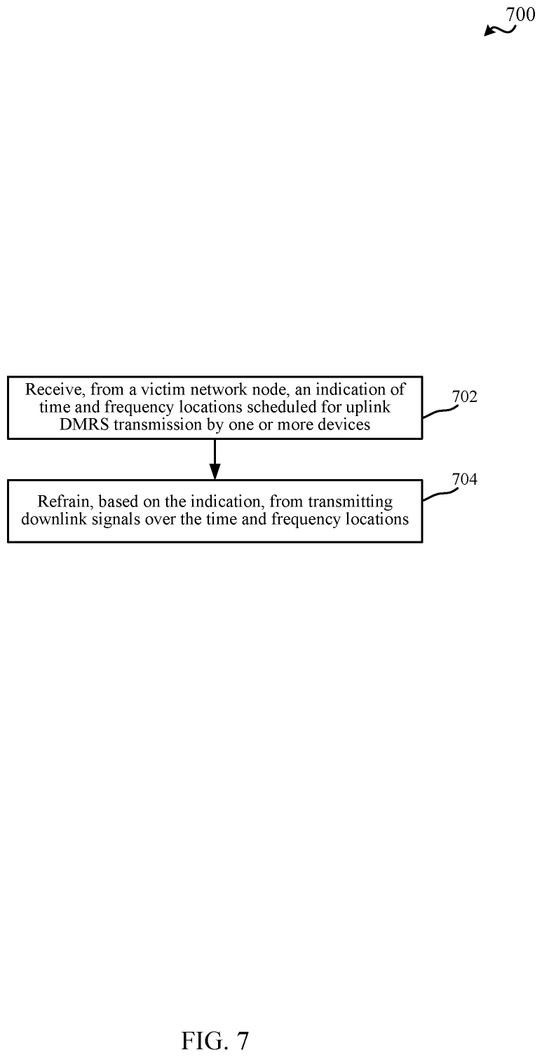

FIG. 6 illustrates a flow chart of an example of a method 600 for indicating certain uplink resources to an aggressor network node for avoiding downlink transmissions, in accordance with aspects described herein. FIG. 7 illustrates a flow chart of an example of a method 700 for avoiding downlink transmissions over certain uplink resources indicated by a victim network node, in accordance with aspects described herein. In an example, a first network node, such as a base station 102 or gNB, or portion of a disaggregated base station 102 or gNB, etc., operating as a victim network node, can perform the functions described in method 600 using one or more of the components described in FIGS. 1 and 3. In an example, a second network node, such as a base station 102 or gNB, or portion of a disaggregated base station 102 or gNB, etc., operating as an aggressor network node, can perform the functions described in method 700 using one or more of the components described in FIGS. 1 and 3. Though methods 600 and 700 are described in conjunction with one another for ease of explanation, the methods are not required to be performed in conjunction, and different network nodes can, or can be configured to, independently perform the different methods.

In method 600, at Block 602, an indication of time and frequency locations scheduled for uplink DMRS transmission by one or more devices can be transmitted to an aggressor network node. In an aspect, interference mitigating component 342, e.g., in conjunction with processor(s) 312, memory 316, transceiver 302, etc., of a victim network node can transmit, to the aggressor network node, the indication of time and frequency locations scheduled for uplink DMRS transmission by one or more devices. For example, the victim network node can schedule one or more devices for uplink transmission, and for uplink DMRS transmission in certain time and frequency resources. The interference mitigating component 342 of the victim network node, in this example, can signal to the aggressor network node (e.g., via BH or OTA signaling) of the uplink DMRS time and frequency locations so the aggressor network node can avoid downlink transmission on the uplink DMRS resources, which can improve uplink channel estimation at the victim network node.

In method 700, at Block 702, an indication of time and frequency locations scheduled for uplink DMRS transmission by one or more devices can be received from a victim network node. In an aspect, interference mitigating component 342, e.g., in conjunction with processor(s) 312, memory 316, transceiver 302, etc., of an aggressor network node can receive, from the victim network node, the indication of time and frequency locations scheduled for uplink DMRS transmission by the one or more devices. The interference mitigating component 342 of the aggressor network node, in this example, can receive the indication via BH or OTA signaling from the victim network node.

In method 700, at Block 704, transmitting downlink signals over the time and frequency locations can be refrained from based on the indication. In an aspect, interference mitigating component 342, e.g., in conjunction with processor(s) 312, memory 316, transceiver 302, etc., of an aggressor network node can refrain, based on the indication, from transmitting (or scheduling transmission of) downlink signals over the time and frequency locations of the uplink DMRS transmissions. This can free the resources from interference to the uplink DMRS transmissions, which can improve channel estimation at the victim network node.

In method 600, at Block 604, the uplink DMRS transmission can be received from the one or more devices over the time and frequency locations. In an aspect, transceiver 302, e.g., in conjunction with processor(s) 312, memory 316, etc., of a victim network node can receive, over the time and frequency locations, the uplink DMRS transmission from the one or more devices. In method 600, at Block 606, uplink channel estimation can be performed based on the uplink DMRS transmission. In an aspect, processor(s) 312, e.g., in conjunction with memory 316, transceiver 302, etc., of a victim network node can perform the uplink channel estimation of an uplink channel, received from the one or more devices, based on the DMRS transmission. In this example, the DMRS transmission can be received at the victim network node without interference from downlink transmissions of other network nodes, which can improve the channel estimation for receiving and decoding the corresponding uplink transmissions.

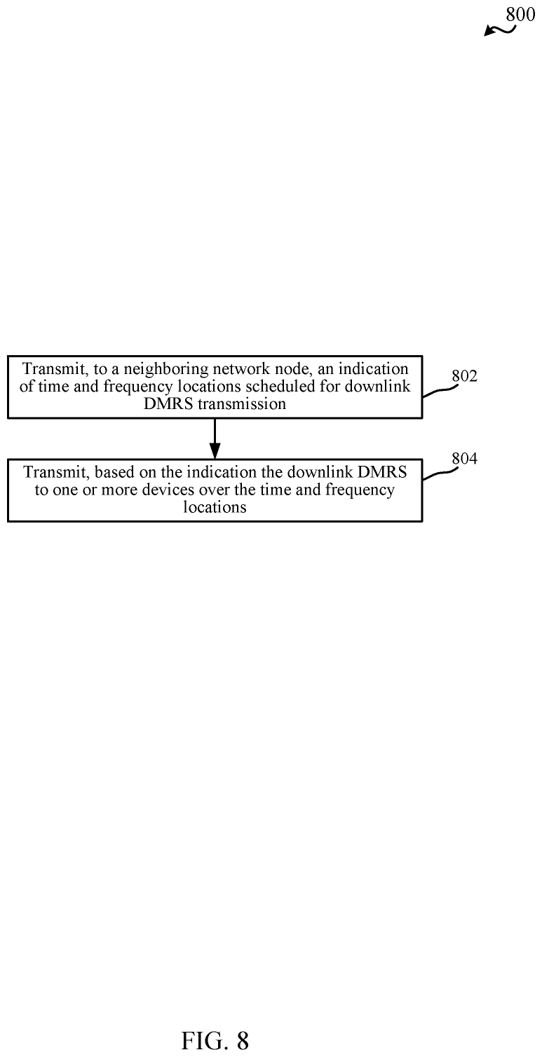

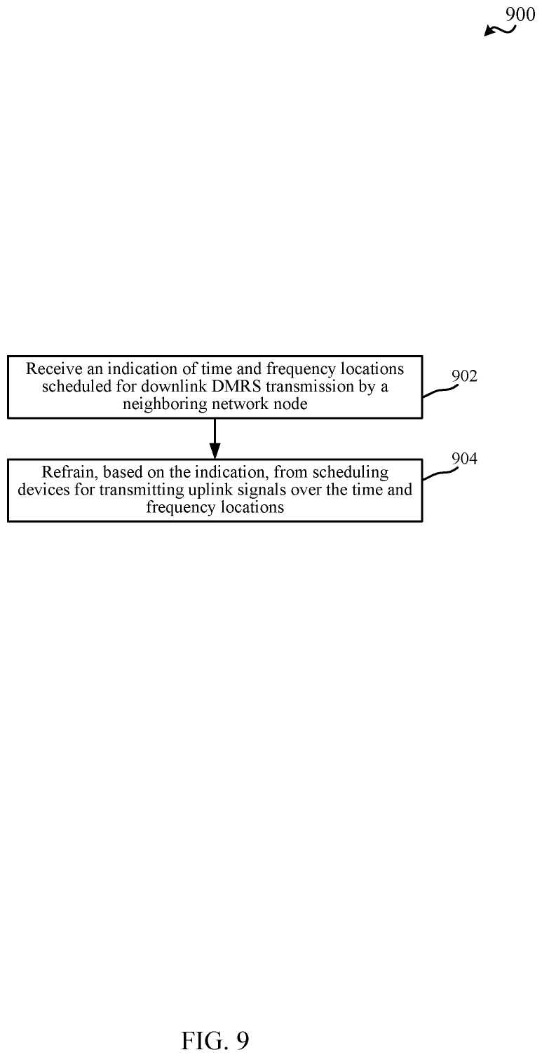

FIG. 8 illustrates a flow chart of an example of a method 800 for indicating certain downlink resources to an aggressor network node for avoiding scheduling uplink transmissions, in accordance with aspects described herein. FIG. 9 illustrates a flow chart of an example of a method 900 for avoiding scheduling uplink transmissions over certain uplink resources indicated by a victim network node, in accordance with aspects described herein. In an example, a first network node, such as a base station 102 or gNB, or portion of a disaggregated base station 102 or gNB, etc., operating as a victim network node, can perform the functions described in method 800 using one or more of the components described in FIGS. 1 and 3. In an example, a second network node, such as a base station 102 or gNB, or portion of a disaggregated base station 102 or gNB, etc., operating as an aggressor network node, can perform the functions described in method 900 using one or more of the components described in FIGS. 1 and 3. Though methods 800 and 900 are described in conjunction with one another for ease of explanation, the methods are not required to be performed in conjunction, and different network nodes can, or can be configured to, independently perform the different methods.

In method 800, at Block 802, an indication of time and frequency locations scheduled for downlink DMRS transmission can be transmitted to a neighboring network node. In an aspect, interference mitigating component 342, e.g., in conjunction with processor(s) 312, memory 316, transceiver 302, etc., of a victim network node can transmit, to the neighboring node (e.g., an aggressor network node) the indication of time and frequency locations scheduled for downlink DMRS transmission. For example, the victim network node can schedule downlink DMRS in certain time and frequency resources. The interference mitigating component 342 of the victim network node, in this example, can signal to the aggressor network node (e.g., via BH or OTA signaling) of the downlink DMRS time and frequency locations so the aggressor network node can avoid scheduling devices for uplink transmission on the downlink DMRS resources, which can improve downlink channel estimation by devices served by the victim network node.

In method 900, at Block 902, an indication of time and frequency locations scheduled for downlink DMRS transmission by a neighboring network node can be received. In an aspect, interference mitigating component 342, e.g., in conjunction with processor(s) 312, memory 316, transceiver 302, etc., of an aggressor network node can receive the indication of time and frequency locations scheduled for downlink DMRS transmission by the neighboring network node (e.g., a victim network node). The interference mitigating component 342 of the aggressor network node, in this example, can receive the indication via BH or OTA signaling from the victim network node. In another example, interference mitigating component 342 of the aggressor network node can determine the time and frequency locations based on a wireless communication technology specification or standard (e.g., 5G NR standard), as coded or indicated by parameter values or instructions stored in memory 316, etc.

In method 900, at Block 904, scheduling devices for transmitting uplink signals over the time and frequency locations can be refrained from based on the indication. In an aspect, interference mitigating component 342, e.g., in conjunction with processor(s) 312, memory 316, transceiver 302, etc., of an aggressor network node can refrain, based on the indication, from scheduling devices for transmitting uplink signals over the time and frequency locations of the downlink DMRS transmissions. This can free the resources from interference to the downlink DMRS transmissions, which can improve downlink channel estimation at devices served by the victim network node.

In method 800, at Block 804, the downlink DMRS can be transmitted, based on the indication, to one or more devices over the time and frequency locations. In an aspect, transceiver 302, e.g., in conjunction with processor(s) 312, memory 316, etc., of a victim network node can transmit, based on the indication, the downlink DMRS to one or more devices over the time and frequency locations. In this example, the DMRS transmission can be transmitted by the victim network node and/or received by served devices without interference from uplink transmissions of devices served at neighboring network nodes.

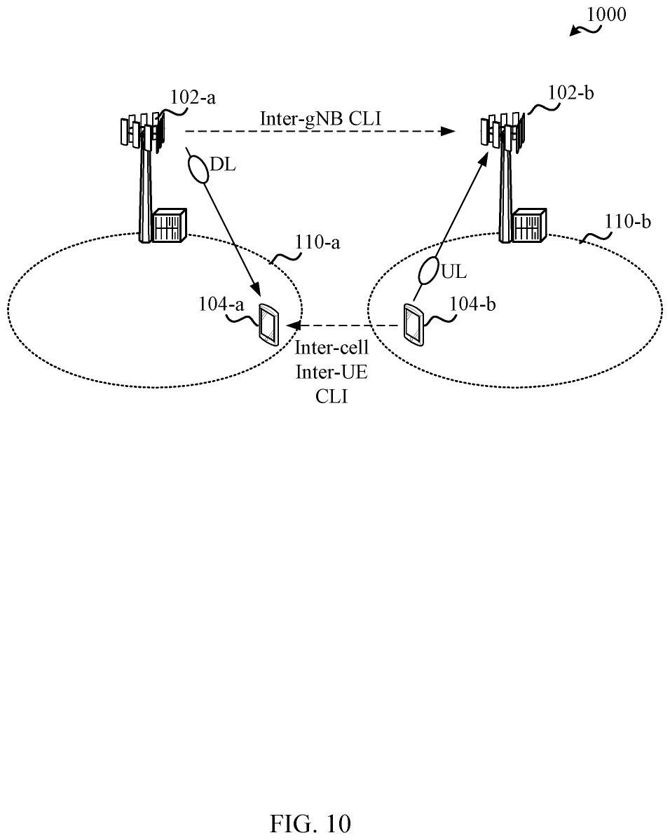

FIG. 10 illustrates an example of a wireless communication system 1000 with possible cross-link interference (CLI), in accordance with aspects described herein. Wireless communication system 1000 includes base station 102-a and 102-b, which can provide respective cells 110-a and 110-b. Wireless communication system 1100 also includes a UE 104-a communicating with base station 102-a in cell 110-a, and UE 104-b communicating with base station 102-b in cell 110-b. In this example, base station 102-a can transmit downlink signals to UE 104-a, and base station 102-b can receive uplink signals from UE 104-b in the same or similar (e.g., overlapping) time and/or frequency resources, and the base stations 102-a and 102-b may support FD. In this example, base station 102-a transmission of downlink signals to UE 104-a may cause inter-gNB CLI to base station 102-b receiving uplink signals from UE 104-b. Similarly, for example, UE 104-b transmission of uplink signals to the base station 102-b can cause inter-cell inter-UE CLI to UE 104-a receiving downlink signals from base station 102-a.

In examples described herein, the inter-gNB CLI and/or inter-cell inter-UE CLI can be avoided or otherwise cancelled. For example, Base station 102-a can be the aggressor network node and base station 102-b can be the victim network node that can indicate the capability to cancel inter-gNB interference from the aggressor network node, perform the training phase to measure RSs received from the aggressor network node, etc., as described above. In another example, the base station 102-b as victim network node can transmit, to the base station 102-a as aggressor network node, the indication of time and frequency locations scheduled for uplink DMRS transmission by UE 104-b. In this example, base station 102-a can refrain from transmitting downlink communications over the time and frequency locations so the base station 102-b can receive the uplink DMRS from UE 104-b without inter-gNB interference from base station 102-a. In another example, the base station 102-a as victim network node can transmit, to the base station 102-b as aggressor network node, the indication of time and frequency locations scheduled for downlink DMRS transmission by the base station 102-a to UE 104-a. In this example, base station 102-b can refrain from scheduling the UE 104-b for uplink transmissions over the time and frequency locations so the UE 104-a can receive the downlink DMRS from base station 102-a without inter-cell inter-UE CLI from UE 104-b.

FIG. 11 is a block diagram of a MIMO communication system 1100 including a base station 102 and a UE 104. The MIMO communication system 1100 may illustrate aspects of the wireless communication access network 100 described with reference to FIG. 1. The base station 102 may be an example of aspects of the base station 102 described with reference to FIG. 1. The base station 102 may be equipped with antennas 1134 and 1135, and the UE 104 may be equipped with antennas 1152 and 1153. In the MIMO communication system 1100, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1120 may receive data from a data source. The transmit processor 1120 may process the data. The transmit processor 1120 may also generate control symbols or reference symbols. A transmit MIMO processor 1130 may perform spatial processing (e.g., precoding) on data symbols, control symbols, or reference symbols, if applicable, and may provide output symbol streams to the transmit modulator/demodulators 1132 and 1133. Each modulator/demodulator 1132 through 1133 may process a respective output symbol stream (e.g., for OFDM, etc.) to obtain an output sample stream. Each modulator/demodulator 1132 through 1133 may further process (e.g., convert to analog, amplify, filter, and upconvert) the output sample stream to obtain a DL signal. In one example, DL signals from modulator/demodulators 1132 and 1133 may be transmitted via the antennas 1134 and 1135, respectively.

At the UE 104, the UE antennas 1152 and 1153 may receive the DL signals from the base station 102 and may provide the received signals to the modulator/demodulators 1154 and 1155, respectively. Each modulator/demodulator 1154 through 1155 may condition (e.g., filter, amplify, downconvert, and digitize) a respective received signal to obtain input samples. Each modulator/demodulator 1154 through 1155 may further process the input samples (e.g., for OFDM, etc.) to obtain received symbols. A MIMO detector 1156 may obtain received symbols from the modulator/demodulators 1154 and 1155, perform MIMO detection on the received symbols, if applicable, and provide detected symbols. A receive (Rx) processor 1158 may process (e.g., demodulate, deinterleave, and decode) the detected symbols, providing decoded data for the UE 104 to a data output, and provide decoded control information to a processor 1180, or memory 1182.

On the uplink (UL), at the UE 104, a transmit processor 1164 may receive and process data from a data source. The transmit processor 1164 may also generate reference symbols for a reference signal. The symbols from the transmit processor 1164 may be precoded by a transmit MIMO processor 1166 if applicable, further processed by the modulator/demodulators 1154 and 1155 (e.g., for single carrier-FDMA, etc.), and be transmitted to the base station 102 in accordance with the communication parameters received from the base station 102. At the base station 102, the UL signals from the UE 104 may be received by the antennas 1134 and 1135, processed by the modulator/demodulators 1132 and 1133, detected by a MIMO detector 1136 if applicable, and further processed by a receive processor 1138. The receive processor 1138 may provide decoded data to a data output and to the processor 1140 or memory 1142.

The processor 1140 may in some cases execute stored instructions to instantiate a interference mitigating component 342 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 1100. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1100.

The following aspects are illustrative only and aspects thereof may be combined with aspects of other embodiments or teaching described herein, without limitation.

Aspect 1 is a method for wireless communication at a network node including indicating, to an aggressor network node, a capability to cancel interference from the aggressor network node, receiving one or more uplink signals from a device along with one or more downlink signals from the aggressor network node in a same time period, and cancelling, based on the capability, the one or more downlink signals received from the aggressor network node from the one or more uplink signals received from the device.

In Aspect 2, the method of Aspect 1 includes where indicating the capability includes transmitting the capability to the aggressor network node using backhaul signaling or over-the-air signaling.

In Aspect 3, the method of Aspect 2 includes where transmitting the capability includes transmitting the capability to the aggressor network node using F1 signaling where the network node and the aggressor network node correspond to the same centralized unit or using F1 and Xn signaling where the network node and the aggressor network node correspond to different centralized units.

In Aspect 4, the method of any of Aspects 1 to 3 includes where indicating the capability includes transmitting one or more parameters related to the capability that allows the aggressor network node to transmit the one or more downlink signals over an uplink symbol over which the one or more uplink signals are received from the device.

In Aspect 5, the method of Aspect 4 includes where the one or more parameters indicate a transmit power limit for transmitting the one or more downlink signals or a time offset for transmitting the one or more downlink signals.

In Aspect 6, the method of any of Aspects 1 to 5 includes performing, based on the capability and during a training phase, channel estimation of one or more reference signals received from the aggressor network node in time and frequency locations determined for the one or more reference signals, where cancelling the one or more downlink signals is based on the channel estimation.

In Aspect 7, the method of Aspect 6 includes where the one or more reference signals include a DMRS, and where performing the channel estimation is based on the time and frequency locations determined for the DMRS.

In Aspect 8, the method of Aspect 7 includes where the one or more reference signals includes an aperiodic, periodic, or semi-persistent DMRS.

In Aspect 9, the method of any of Aspects 7 or 8 includes where the channel estimation is MIMO channel estimation, and further comprising receiving, from the aggressor network node, an indication of the time and frequency locations as a RE pattern including one or more of a number of CDM groups, per-CDM group RE allocation, or associated DMRS ports for the MIMO channel estimation using the DMRS.

In Aspect 10, the method of any of Aspects 6 to 9 includes where the one or more reference signals include a CSI-RS, a SSB, a DMRS of a CORESET, or a training reference signal, and where performing the channel estimation is based on the time and frequency locations determined for the CSI-RS, SSB, DMRS, or training reference signal.

In Aspect 11, the method of any of Aspects 6 to 10 includes requesting, from the aggressor network node, the time and frequency locations for the one or more reference signals.

In Aspect 12, the method of any of Aspects 6 to 11 includes receiving, from the aggressor network node, an indication of the time and frequency locations for the one or more reference signals.

In Aspect 13, the method of any of Aspects 6 to 12 includes refraining from scheduling devices for transmitting during time and frequency locations of the one or more reference signals.

In Aspect 14, the method of any of Aspects 1 to 13 includes performing the channel estimation using a first occasion of a CSI-RS, a SSB, a DMRS of a CORESET, or a training reference signal, where cancelling the one or more downlink signals includes cancelling, based on the channel estimation, a second occasion of the CSI-RS, SSB, or DMRS of the CORESET.

In Aspect 15, the method of any of Aspects 1 to 14 includes receiving, from the aggressor network node, an indication of resources for data scheduling including resources for the one or more downlink signals, where cancelling the one or more downlink signals is based on the indication of resources.

Aspect 16 is a method for wireless communication at a network node including transmitting, to an aggressor network node, an indication of time and frequency locations scheduled for uplink DMRS transmission by one or more devices, receiving, over the time and frequency locations, the uplink DMRS transmission from the one or more devices, and performing uplink channel estimation based on the uplink DMRS transmission.

In Aspect 17, the method of Aspect 16 includes where the aggressor network node refrains from transmitting downlink signals during the time and frequency locations based on the indication of the time and frequency locations.

Aspect 18 is a method for wireless communication at a network node including receiving an indication of time and frequency locations scheduled for downlink DMRS transmission by a neighboring network node, and refraining, based on the indication, from scheduling devices for transmitting uplink signals over the time and frequency locations.

In Aspect 19, the method of Aspect 18 includes where the indication is received from the neighboring network node.

Aspect 20 is a method for wireless communication at a network node including receiving, from a victim network node, a capability to cancel interference from the network node, and transmitting, based on the capability, one or more downlink signals in an uplink symbol for the victim network node over which one or more devices transmit uplink signals to the victim network node.

In Aspect 21, the method of Aspect 20 includes where receiving the capability includes receiving the capability from the victim network node using backhaul or over-the-air signaling.

In Aspect 22, the method of Aspect 21 includes where receiving the capability includes receiving the capability from the victim network node using F1 signaling where the network node and the victim network node correspond to the same centralized unit or using F1 and Xn signaling where the network node and the victim network node correspond to different centralized units.

In Aspect 23, the method of any of Aspects 20 to 22 includes where receiving the capability includes receiving one or more parameters related to the capability that allows the network node to transmit the one or more downlink signals over the uplink symbol.

In Aspect 24, the method of Aspect 23 includes where the one or more parameters indicate a transmit power limit for transmitting the one or more downlink signals or a time offset for transmitting the one or more downlink signals.

In Aspect 25, the method of any of Aspects 20 to 24 includes receiving, from the victim network node, a request to indicate time and frequency locations for one or more reference signals used in a training phase to cancel the one or more downlink signals from the uplink symbol.

In Aspect 26, the method of any of Aspects 20 to 25 includes transmitting, to the victim network node, an indication of time and frequency locations for one or more reference signals used in a training phase to cancel the one or more downlink signals from the uplink symbol.

In Aspect 27, the method of any of Aspects 20 to 26 includes transmitting, to the victim network node, an indication of resources for data scheduling including resources for the one or more downlink signals.

Aspect 28 is a method for wireless communication at a network node including receiving an indication of time and frequency locations scheduled for uplink DMRS transmission by one or more devices to a victim network node, and refraining, based on the indication, from transmitting downlink signals over the time and frequency locations.

In Aspect 29, the method of Aspect 28 includes where receiving the indication includes receiving the indication from the victim network node.

Aspect 30 is a method for wireless communication at a network node including transmitting, to a neighboring network node, an indication of time and frequency locations scheduled for downlink DMRS transmission, and transmitting, based on the indication, a downlink DMRS to one or more devices over the time and frequency locations.

Aspect 31 is an apparatus for wireless communication including a processor, memory coupled with the processor, and instructions stored in the memory and operable, when executed by the processor, to cause the apparatus to perform any of the methods of Aspects 1 to 30.

Aspect 32 is an apparatus for wireless communication including means for performing any of the methods of Aspects 1 to 30.

Aspect 33 is a computer-readable medium including code executable by one or more processors for wireless communications, the code including code for performing any of the methods of Aspects 1 to 30.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a processor;
memory coupled with the processor; and
instructions stored in the memory and operable, when executed by the processor, to cause the apparatus to:
indicate, to an aggressor network node, a capability to cancel interference from the aggressor network node;
receive one or more uplink signals from a device along with one or more downlink signals from the aggressor network node in a same time period; and
cancel, based on the capability, the one or more downlink signals received from the aggressor network node from the one or more uplink signals received from the device.

2. The apparatus of claim 1, wherein the instructions, when executed by the processor, cause the apparatus to indicate the capability at least in part by transmitting the capability to the aggressor network node using backhaul signaling or over-the-air signaling.

3. The apparatus of claim 2, wherein the instructions, when executed by the processor, cause the apparatus to transmit the capability to the aggressor network node using F1 signaling where the network node and the aggressor network node correspond to the same centralized unit or using F1 and Xn signaling where the network node and the aggressor network node correspond to different centralized units.

4. The apparatus of claim 1, wherein the instructions, when executed by the processor, cause the apparatus to indicate the capability at least in part by transmitting one or more parameters related to the capability that allows the aggressor network node to transmit the one or more downlink signals over an uplink symbol over which the one or more uplink signals are received from the device.

5. The apparatus of claim 4, wherein the one or more parameters indicate a transmit power limit for transmitting the one or more downlink signals or a time offset for transmitting the one or more downlink signals.

6. The apparatus of claim 1, wherein the instructions, when executed by the processor, cause the apparatus to perform, based on the capability and during a training phase, channel estimation of one or more reference signals received from the aggressor network node in time and frequency locations determined for the one or more reference signals, wherein the instructions, when executed by the processor, cause the apparatus to cancel the one or more downlink signals based on the channel estimation.

7. The apparatus of claim 6, wherein the one or more reference signals include a demodulation reference signal (DMRS), and wherein performing the channel estimation is based on the time and frequency locations determined for the DMRS.

8. The apparatus of claim 7, wherein the one or more reference signals includes an aperiodic, periodic, or semi-persistent DMRS.

9. The apparatus of claim 7, wherein the channel estimation is multiple-input multiple-output (MIMO) channel estimation, and wherein the instructions, when executed by the processor, cause the apparatus to receive, from the aggressor network node, an indication of the time and frequency locations as a resource element (RE) pattern including one or more of a number of code division multiplexing (CDM) groups, per-CDM group RE allocation, or associated DMRS ports for the MIMO channel estimation using the DMRS.

10. The apparatus of claim 6, wherein the one or more reference signals include a channel state information reference signal (CSI-RS), a synchronization signal block (SSB), a demodulation reference signal (DMRS) of a control resource set (CORESET), or a training reference signal, and wherein performing the channel estimation is based on the time and frequency locations determined for the CSI-RS, SSB, DMRS, or training reference signal.

11. The apparatus of claim 6, wherein the instructions, when executed by the processor, cause the apparatus to request, from the aggressor network node, the time and frequency locations for the one or more reference signals.

12. The apparatus of claim 6, wherein the instructions, when executed by the processor, cause the apparatus to receive, from the aggressor network node, an indication of the time and frequency locations for the one or more reference signals.

13. The apparatus of claim 6, wherein the instructions, when executed by the processor, cause the apparatus to refrain from scheduling devices for transmitting during time and frequency locations of the one or more reference signals.

14. The apparatus of claim 1, wherein the instructions, when executed by the processor, cause the apparatus to perform the channel estimation using a first occasion of a channel state information reference signal (CSI-RS), a synchronization signal block (SSB), a demodulation reference signal (DMRS) of a control resource set (CORESET), or a training reference signal, wherein the instructions, when executed by the processor, cause the apparatus to cancel the one or more downlink signals at least in part by cancelling, based on the channel estimation, a second occasion of the CSI-RS, SSB, or DMRS of the CORESET.

15. The apparatus of claim 1, wherein the instructions, when executed by the processor, cause the apparatus to receive, from the aggressor network node, an indication of resources for data scheduling including resources for the one or more downlink signals, wherein the instructions, when executed by the processor, cause the apparatus to cancel the one or more downlink signals based on the indication of resources.

16. An apparatus for wireless communication, comprising:
a processor;
memory coupled with the processor; and
instructions stored in the memory and operable, when executed by the processor, to cause the apparatus to:
receive, from a victim network node, a capability to cancel interference from the network node; and
transmit, based on the capability, one or more downlink signals in an uplink symbol for the victim network node over which one or more devices transmit uplink signals to the victim network node.

17. The apparatus of claim 16, wherein the instructions, when executed by the processor, cause the apparatus to receive the capability from the victim network node using backhaul or over-the-air signaling.

18. The apparatus of claim 17, wherein the instructions, when executed by the processor, cause the apparatus to receive the capability from the victim network node using F1 signaling where the network node and the victim network node correspond to the same centralized unit or using F1 and Xn signaling where the network node and the victim network node correspond to different centralized units.

19. The apparatus of claim 16, wherein the instructions, when executed by the processor, cause the apparatus to receive the capability at least in part by receiving one or more parameters related to the capability that allows the network node to transmit the one or more downlink signals over the uplink symbol.

20. The apparatus of claim 19, wherein the one or more parameters indicate a transmit power limit for transmitting the one or more downlink signals or a time offset for transmitting the one or more downlink signals.

21. The apparatus of claim 16, wherein the instructions, when executed by the processor, cause the apparatus to receive, from the victim network node, a request to indicate time and frequency locations for one or more reference signals used in a training phase to cancel the one or more downlink signals from the uplink symbol.

22. The apparatus of claim 16, wherein the instructions, when executed by the processor, cause the apparatus to transmit, to the victim network node, an indication of time and frequency locations for one or more reference signals used in a training phase to cancel the one or more downlink signals from the uplink symbol.

23. The apparatus of claim 16, wherein the instructions, when executed by the processor, cause the apparatus to transmit, to the victim network node, an indication of resources for data scheduling including resources for the one or more downlink signals.

24. A method for wireless communication at a network node, comprising:
indicating, to an aggressor network node, a capability to cancel interference from the aggressor network node;
receiving one or more uplink signals from a device along with one or more downlink signals from the aggressor network node in a same time period; and
cancelling, based on the capability, the one or more downlink signals received from the aggressor network node from the one or more uplink signals received from the device.

25. The method of claim 24, wherein indicating the capability includes transmitting the capability to the aggressor network node using backhaul signaling or over-the-air signaling.

26. The method of claim 25, wherein transmitting the capability includes transmitting the capability to the aggressor network node using F1 signaling where the network node and the aggressor network node correspond to the same centralized unit or using F1 and Xn signaling where the network node and the aggressor network node correspond to different centralized units.

27. The method of claim 24, wherein indicating the capability includes transmitting one or more parameters related to the capability that allows the aggressor network node to transmit the one or more downlink signals over an uplink symbol over which the one or more uplink signals are received from the device.

28. The method of claim 27, wherein the one or more parameters indicate a transmit power limit for transmitting the one or more downlink signals or a time offset for transmitting the one or more downlink signals.

29. A method for wireless communication at a network node, comprising:
receiving, from a victim network node, a capability to cancel interference from the network node; and
transmitting, based on the capability, one or more downlink signals in an uplink symbol for the victim network node over which one or more devices transmit uplink signals to the victim network node.

30. The method of claim 29, wherein receiving the capability includes receiving the capability from the victim network node using backhaul or over-the-air signaling.
